(19) United States
(12) Patent Application Publication
(10) Pub. No.: US 2009/0115203 A1
(43) Pub. Date: May 7, 2009

(54) DOOR WITH RETRACTABLE SCREEN

(76) Inventors: Bruce E. Thomas, Brookings, SD (US); Kelly D. Nordgaard, Brookings, SD (US); Bryan P. Zacher, Brookings, SD (US); Alan M. Dixon, Brookings, SD (US); Allen E. Lee, Brookings, SD (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/352,494

(22) Filed: Jan. 12, 2009

Related U.S. Application Data
(63) Continuation of application No. 11/834,323, filed on Aug. 6, 2007, now abandoned.
Application No. 11/834,323 is a continuation of application No. 10/901,915, filed on Jul. 29, 2004, now abandoned.
Application No. 10/901,915 is a continuation-in-part of application No. 10/606,039, filed on Jun. 25, 2003, now abandoned.
Application No. 10/606,039 is a continuation-in-part of application No. 10/212,465, filed on Aug. 5, 2002, now Pat. No. 6,618,998.
(60) Provisional application No. 60/310,557, filed on Aug. 7, 2001.

(51) Int. Cl. E05B 3/00

(52) U.S. Cl. 292/336.3

(57) ABSTRACT

A door incorporating at least one movable glass insert or window sash slidably disposed in at least one track thereof. An end of the insert is coupled to an end of a spring biased roll of screen. As the insert moves from the spring biased roll, the screen is extracted therefrom providing a continuously variable screened region in the door. The insert can be positioned using a counterbalance, spaced apart latchable locations in the door, frictional engagement, or through the tension force of the biased roll of screen. A catch mechanism is disposed on the movable glass insert to detachably couple the glass insert to a portion of the door.

### RELATED APPLICATIONS

The present application is a continuation of U.S. patent application Ser. No. 11/834,323, filed Aug. 6, 2007, which is a continuation of U.S. patent application Ser. No. 10/901,915, filed Jul. 29, 2004, which is a continuation-in-part of U.S. patent application Ser. No. 10/606,039, filed Jun. 25, 2003, which is a continuation of U.S. patent application Ser. No. 10/212,465, filed Aug. 5, 2002, now U.S. Pat. No. 6,618,998, issued Sep. 16, 2003, which in turn claims the benefit of U.S. Provisional Application No. 60/310,557, filed Aug. 7, 2001, each of which is hereby fully incorporated herein by reference.

### FIELD OF THE INVENTION

The invention pertains to doors. More particularly, the invention pertains to doors having at least one slidable glass pane or panel with an extendable screen attached thereto.

### BACKGROUND OF THE INVENTION

Doors which incorporate panes of glass and screens are known. Some forms of such doors include screens which are fixedly mounted to the frame of the door with sliding glass inserts. With these doors, the inserts usually can be locked into a plurality of vertical positions with spring loaded latches to expose varying degrees of screen. When the inserts are moved to their fully closed position, such as during storms or in cold weather, a person looking at the door, must look through at least one pane of glass and the screen.

In other forms of doors, glass inserts or screen inserts are installed on the door's frame depending on the season. In warmer weather the glass insert is removed and a screen insert is used in the frame. In cooler weather, the screen is removed and a glass insert is attached to the frame. With such doors, an individual looking at the door looks through either a pane of glass or a screen but typically not both.

One known door configuration provides a fixed screen with a counterbalanced insert. In this configuration, the insert is not latched at a selected position on its track. The counterbalance makes it possible to position the insert at any desired position of the track. However, when the insert is in its closed position, a person viewing the door must look through both the glass insert and the screen.

Patio door configurations are known which include sliding glass doors which can be opened or closed to provide access to a patio or a porch. Spring biased screen modules are known which can be attached to the patio door frame. These modules include horizontally retractable screens that can be extended across a patio door opening to exclude insects or other flying pests.

While the known doors are generally suitable for their intended purpose, they all suffer from one or more deficiencies in performance, convenience and ease of use. There continues to be a need for multi-season doors which provide convenient and easy to use screened openings during warmer drier weather, while at the same time making it possible to easily close the screened area with a glass pane, that has a view unobstructed by a screen, during cooler or wetter weather. Preferably, such doors could be manufactured, at least in part, using techniques for manufacturing existing doors so as to benefit from the economies of scale that such manufacturing capabilities provide. Additionally, it would be preferable if such doors were easy to maintain and designed to be forgiving in the event that the screen is in need of replacement.

Numerous other advantages and features of the present invention will become readily apparent from the following detailed description of the invention and the embodiments thereof, from the claims and from the accompanying drawings.

### SUMMARY OF THE INVENTION

The present invention is a door that includes first and second spaced apart jambs with each of the spaced apart jambs having at least one track extending axially along a portion thereof. The at least one track of the respective jambs are defined by spaced apart side walls. The door also includes a header and a sill disposed generally transverse to the first and second spaced apart jambs. An adjustable insert is slidably disposed in the at least one track to selectively block an opening in the door defined by the header, sill and spaced apart jambs. A screen disposed about a spring biased roll coupled to the header is provided for permitting airflow through the opening of the door while excluding insects. A free end of the screen is removably securable to the adjustable insert. The screen is deployable under tension from the spring biased roll during displacement of the adjustable insert within the at least one track. Additionally, at least one catch mechanism may be disposed on an end of the adjustable insert for releasably catching a portion of the door when the adjustable insert is disposed generally adjacent to the header.

### BRIEF DESCRIPTION OF THE DRAWINGS

FIG. 1A is a front elevational view of a door in accordance with the present invention;

FIG. 1B is a top plan view of the door of FIG. 1A;

FIG. 1C is a side view of the door of FIG. 1A;

FIG. 2A is a rear elevational view of the door of FIG. 1A;

FIG. 2B is a rear elevational view of an alternate door in accordance with the invention;

FIG. 3A is an exploded view of the door of FIG. 1A;

FIG. 3B is a rear isometric view of the door of FIG. 1A;

FIG. 4A is an exploded view of an alternate embodiment of the door of FIG. 1A;

FIG. 4B is a rear isometric view of the door of FIG. 4A;

FIGS. 5A and B are side sectional views taken along plane 5A-5A of the door of FIG. 1A;

FIG. 5C is a sectional view taken along plane 5C-5C of the door of FIG. 1A;

FIG. 5D is an enlargement of a portion of the section of FIG. 5C;

FIG. 5E is a sectional view taken along plane 5E-5E of FIG. 5A;

FIG. 5F is an enlarged partial view of a portion of the door of FIG. 1A illustrating details thereof;

FIG. 5G is an enlarged partial view illustrating details of an alternate embodiment of the door of FIG. 1A;

FIGS. 6A, 6B and 6C taken together are isometric views illustrating a process of engaging an extendable screen cloth with the jambs of the door of FIG. 1A;

FIGS. 7A-7C illustrate details of a replaceable screen module usable in the door of FIG. 1A;

FIG. 8 is a rear isometric view of the door of FIG. 1A illustrating aspects of removing and replacing the screen module;

FIG. 9 is an enlarged region of a portion of FIG. 8 illustrating additional details thereof;

FIG. 10 is a front elevational view of another door which embodies the invention;

FIG. 10A is a side section of the door of FIG. 10 taken along plane 10A-10A;

FIG. 11 illustrates an end sectional view of a plurality of alternate mechanisms for coupling a retractable screen to a movable door insert; and

FIG. 12A is a rear elevational view of another door in accordance with the present invention;

FIG. 12B is a top view of a screen module cover being attached to the door;

FIG. 13 is a rear elevational view of another door in accordance with the present invention;

FIG. 14 is side sectional view of the door of FIG. 13;

FIG. 15 is an enlarged sectional view a portion of the door of FIG. 13 along plane of 15-15 illustrating an insert in at least one track;

FIG. 16 is an enlarged sectional view of a portion of the door of FIG. 13 along plane 15-15 illustrating a screen material disposed in the at least one track.

FIG. 17 is another sectional view of the door of FIG. 13 illustrating a spring biased roll disposed on the door;

FIG. 18 is a partial sectional view of the FIG. 17;

FIG. 19 is an enlarged partial perspective view of a door illustrating a stop disposed therein;

FIG. 20A is perspective view of the stop of FIG. 19;

FIG. 20B is a side elevational view of the stop of FIG. 19;

FIG. 20C is a bottom view of the stop of FIG. 19;

FIG. 20D is a top view of the stop of FIG. 19;

FIG. 20E is a front elevational view of the stop of FIG. 19;

FIG. 21 is a partial sectional view of the door of FIG. 13 illustrating a portion of the stop disposed in the door;

FIG. 22 is an enlarged sectional view of a door illustrating an insert disposed in a channel of a mullion;

FIG. 23 is another enlarged sectional view of a door illustrating an insert disposed in a channel of a mullion;

FIG. 24 is a perspective view of a catch mechanism of the insert coupled to a cover; and

FIG. 25 is an enlarged cross sectional view of FIG. 24.

### DETAILED DESCRIPTION OF THE PREFERRED EMBODIMENTS

While this invention is susceptible of embodiment in many different forms, there are shown in the drawings and will be described herein in detail specific example embodiments thereof with the understanding that the present disclosure is to be considered as an exemplification of the principles of the invention and is not intended to limit the invention to the specific embodiments illustrated.

In one embodiment of the invention, a door incorporates a replaceable screen module that includes an integral, spring biased, retractable screen that is coupled to a movable glass insert or window sash in the door. As the window sash or insert is moved away from the screen module, the screen is withdrawn from its retracted position and extends along a frame of the door screening the otherwise open region from which the window sash has moved. As the window sash or insert moves toward the screen module, the screen is retracted into the screen module reducing the ventilation region available in the door.

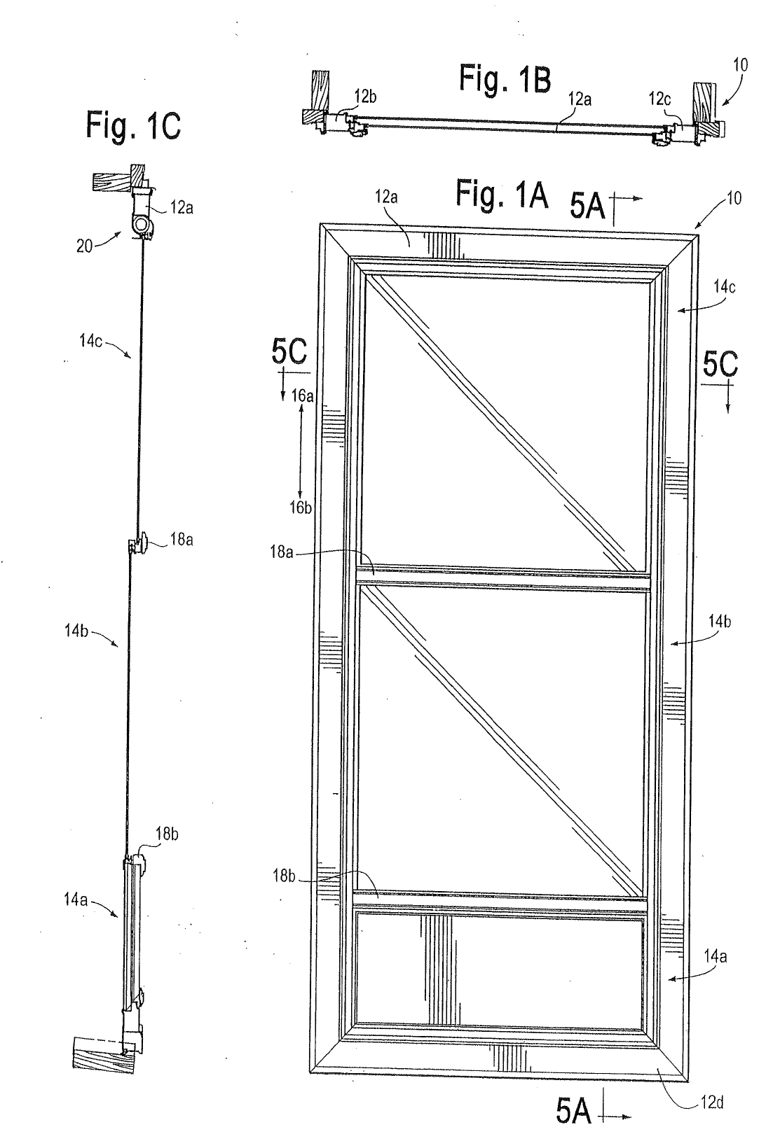

FIGS. 1A-1C illustrate various views of a door 10 that embodies the present invention. The door 10 includes a header 12a, two door jambs 12b, 12c and a sill 12d. The members 12a-12d define a doorframe. The door 10 also includes a kick plate generally indicated at 14a, a lower pane or glass insert 14b, and an upper pane or glass insert at 14c. Mullions 18a and 18b may also be provided on the exterior side of the frame to join jambs 12b and 12c. In the door 10, the pane or insert 14b is fixedly mounted between the jambs 12b, 12c and above the kick plate 14a.

The pane or insert 14c is mounted in tracks, discussed in more detail subsequently, for vertical motion generally in directions 16a and 16b relative to insert 14b. When the insert 14c is positioned at its uppermost location adjacent to header 12a, the door 10 is fully closed with two glass panes as one would use it in cool or wet weather. The pane or insert 14c can be moved, vertically, in direction 16b, away from header 12a thereby opening the upper portion of door 10 for ventilation.

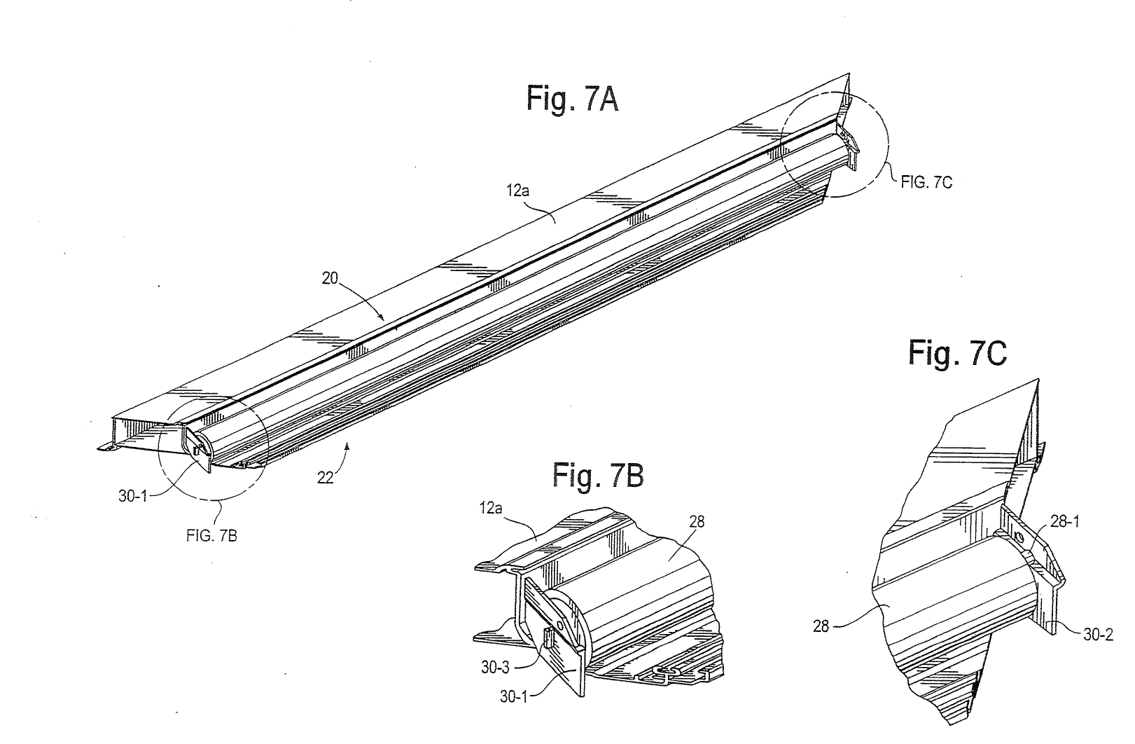

A screen module 20, best seen in FIG. 7A, can be coupled to the jambs 12b, 12c, header 12a or sill 12d. Screen module 20 carries a retracted screen 22-1 which has a free end that carries an attachment member 22 that is coupled to an upper end of insert 14c. As the insert 14c is moved in the direction 16b, screen fabric or material 22-1 from the screen module 20 is extracted therefrom filling any gap or space between an upper end of insert 14c and header 12a to permit air to flow through the space while excluding insects. As the insert 14c is moved in the direction 16b, the screen material 22-1 is kept taut within the tracks.

Door 10 can thus, as described above, be converted from a storm door with two glass panes to a door simply by moving pane or insert 14c vertically downwardly. Where insert 14c is moved vertically downwardly toward kick plate 14a, the extracted screen material 22-1 fills the entire area previously closed or occupied by pane 14c. When the insert 14c is raised, in direction 16a, the screen material 22-1 retracts into screen module 20 for storage. As discussed below, screen module 20 is removable for maintenance or replacement.

It will be understood that alternate configurations to the door 10 come within the spirit and scope of the present invention. For example, the screen module 20 can be mounted at or near the base 12d to provide an openable lower screened region. Alternately, instead of screening material, sheet plastic or other materials could be used in the module 20.

Members 12a-12d of the frame for the door 10 can be formed of metal, such as extruded aluminum, extruded or molded plastic, or partly or completely of a wood product. Inserts 14b,c need not include glass but could in fact be closed with translucent or transparent plastic material without departing from the spirit and scope of the present invention.

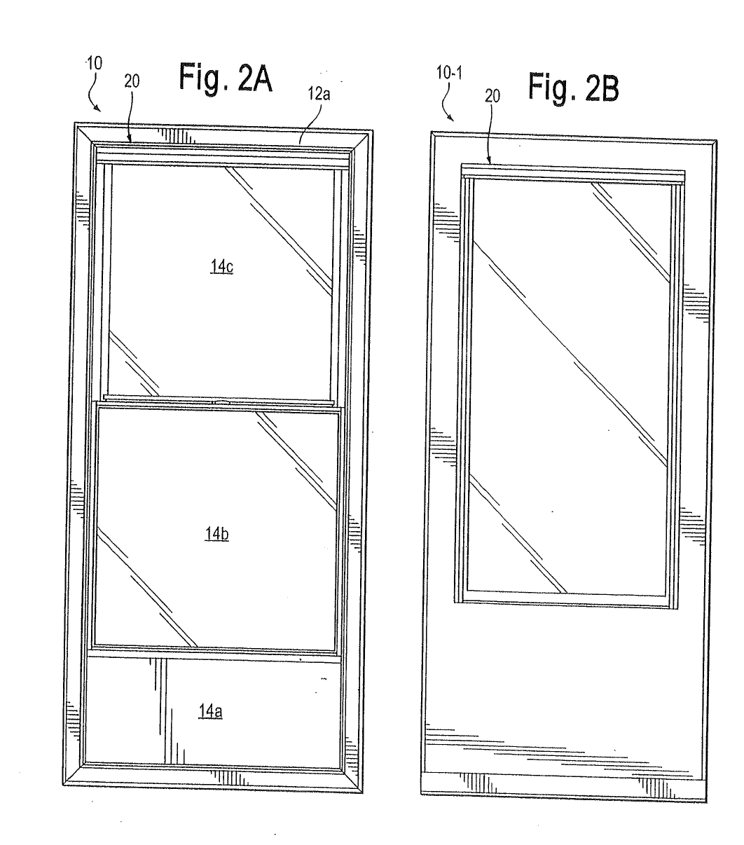

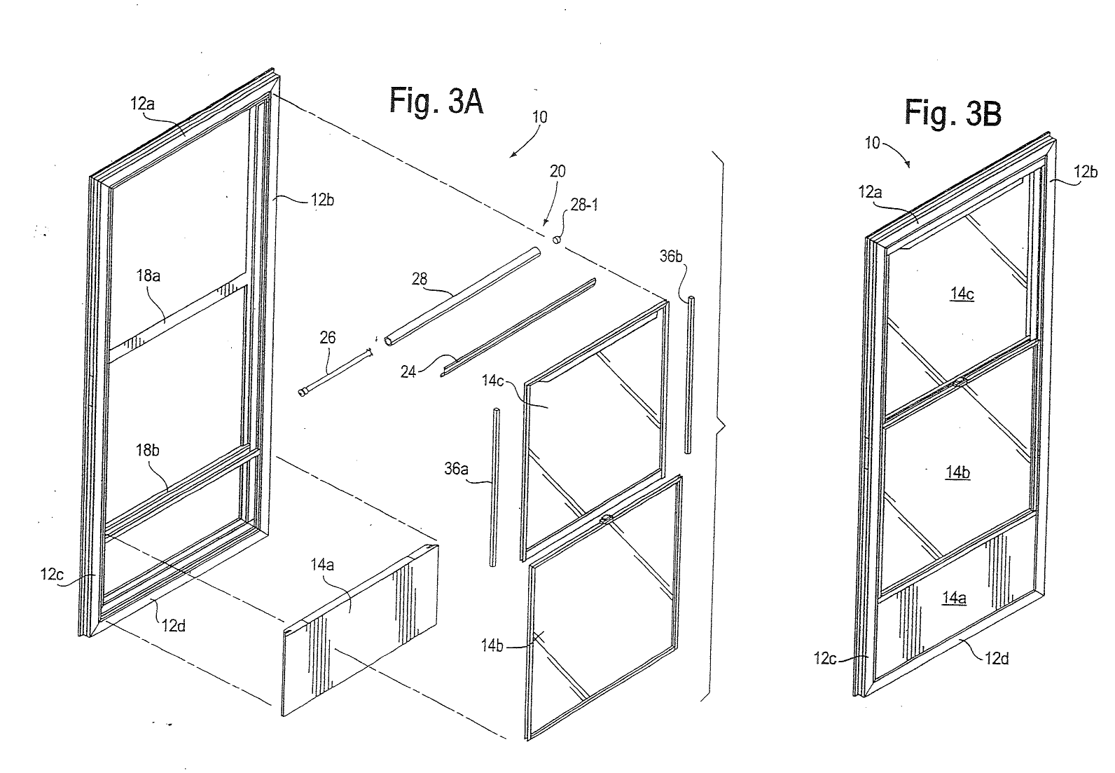

FIG. 2A is a rear elevational view of the door 10 illustrating the location of screen module 20 adjacent to header 12a. As illustrated in FIG. 3A, screen module 20 is preferably enclosed by a removable cover 24 which can be removed for purposes of maintenance and for replacing the screen module 20.

FIG. 2B illustrates an alternate embodiment, a wood core door 10-1, which incorporates screen module 20. The wood core door 10-1 can be formed with a wood-products core covered with either metal, such as aluminum, or cured resin such as vinyl. It will be understood that the screen module 20 is coupled to a sash or insert, comparable to the insert 14c, which moves vertically in the tracks, as would be understood by those of skill, in the frame for the door 10-1.

FIGS. 3A and 3B are an exploded view of the door 10 and a rear isometric view thereof. As illustrated in FIG. 3A, module 20 incorporates a spring or retractor assembly 26 which is carried in a hollow screen roll or cylinder 28. The cylinder 28 rotates about retractor assembly 26 and pivot cap 28-1. The screen module 20 is attached to the door so as to permit rotary motion thereof by brackets 30-1 and 30-2, best seen in FIGS. 7A-C. Screen roll 28 carries the coiled screen material 22-1 with attached connection member 22, best seen in FIG. 7B.

The spring assembly 26 exerts a substantially constant retracting force on the spring fabric on the roll 28 as the insert 14c is moved vertically in directions 16a,b. The screen material 22-1 is thus constantly under tension and disposed generally against an inner surface of the tracks. This tension can sever to control or restrict movement of the insert 14c, much like a counterbalance or latch-based system.

The insert 14c in door 10 may be counterbalanced by counterbalancing mechanisms 36a and 36b. The counterbalancing mechanisms 36a,b move with the insert 14c in the jambs 12b, 12c and are invisible to the user. Types of counterbalances include block and tackle balance, spiral balance and coil spring balance.

The counterbalances 36a and 36b make it possible to smoothly move the insert 14c in the direction 16a or 16b. The insert 14c can be positioned anywhere along its range of travel and will remain there until moved due to the forces exerted by the counterbalance mechanisms 36a and 36b.

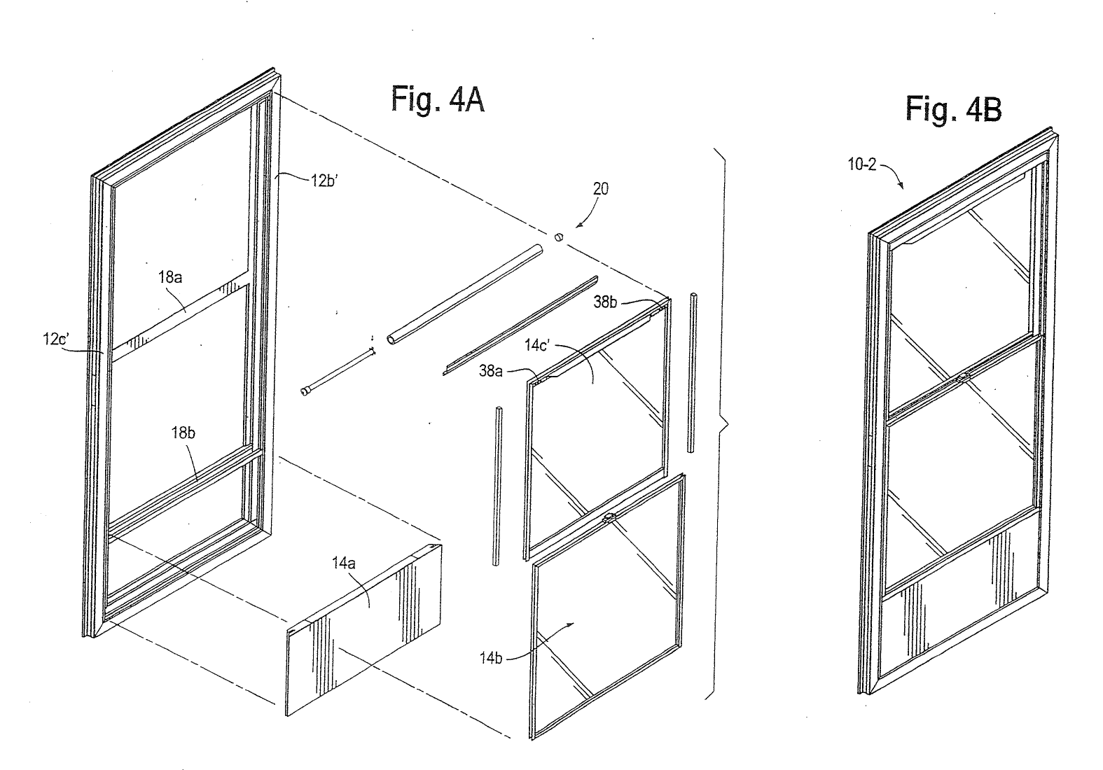

FIGS. 4A and 4B illustrate an alternate embodiment, a door 10-2, which embodies the present invention. Those elements of door 10-2 which correspond to previously discussed elements of the door 10 have been assigned the same identification numerals. As an alternate to the counterbalance mechanisms 36a and 36b, the door 10-2 may incorporate spring biased finger operable latches 38a and 38b which are carried by the insert 14c′. The latches 38a and 38b may extend laterally outwardly into slots in the jambs 12b′, c′ to lock the insert 14c′ into a plurality of spaced apart vertical positions.

In the door 10-2, the insert 14c′ can be moved vertically to a locking position, the movement will retract the screen material 22-1 off of the roll 28 and fill the area of the door frame from which the insert 14c′ has been moved. The mechanical latches 38a and 38b will lock the insert 14c′ at the desired degree of openness in the frame of the door 10-2 desired.

In yet another embodiment, insert 14c can frictionally engage the tracks in jambs 12b,c. The frictional forces will support insert 14c at anv one of a variety of positions. In this embodiment, no counterbalances or latches are needed.

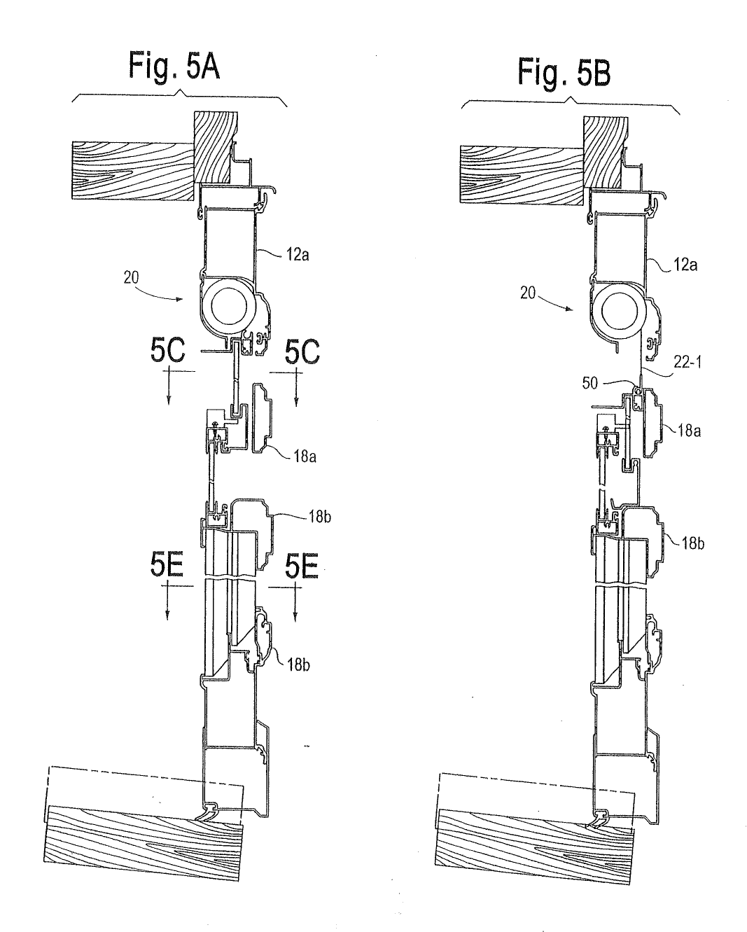

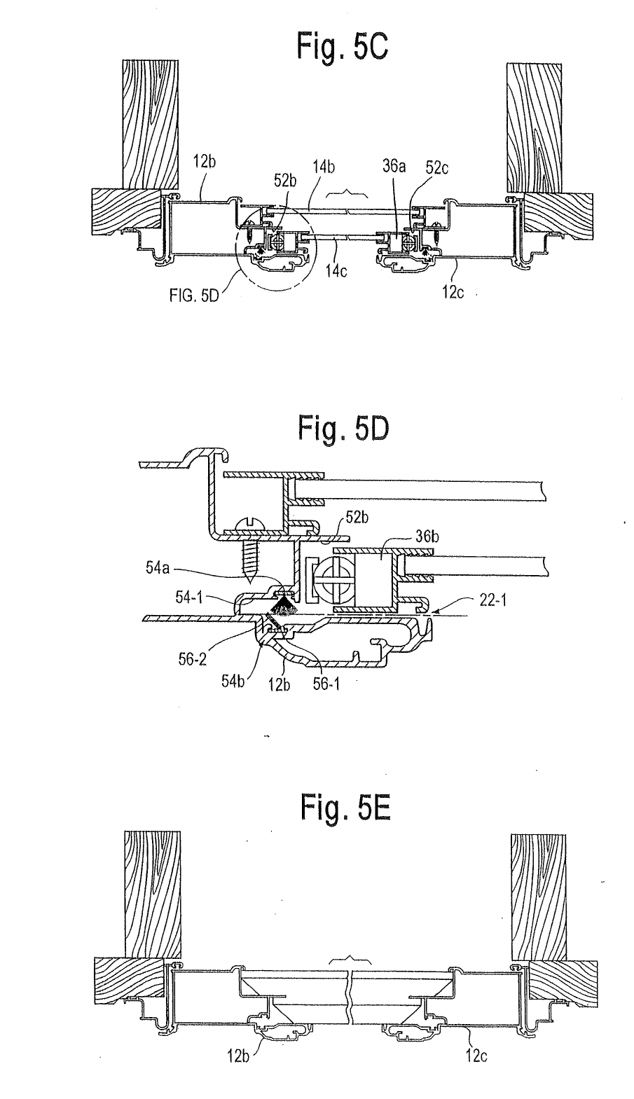

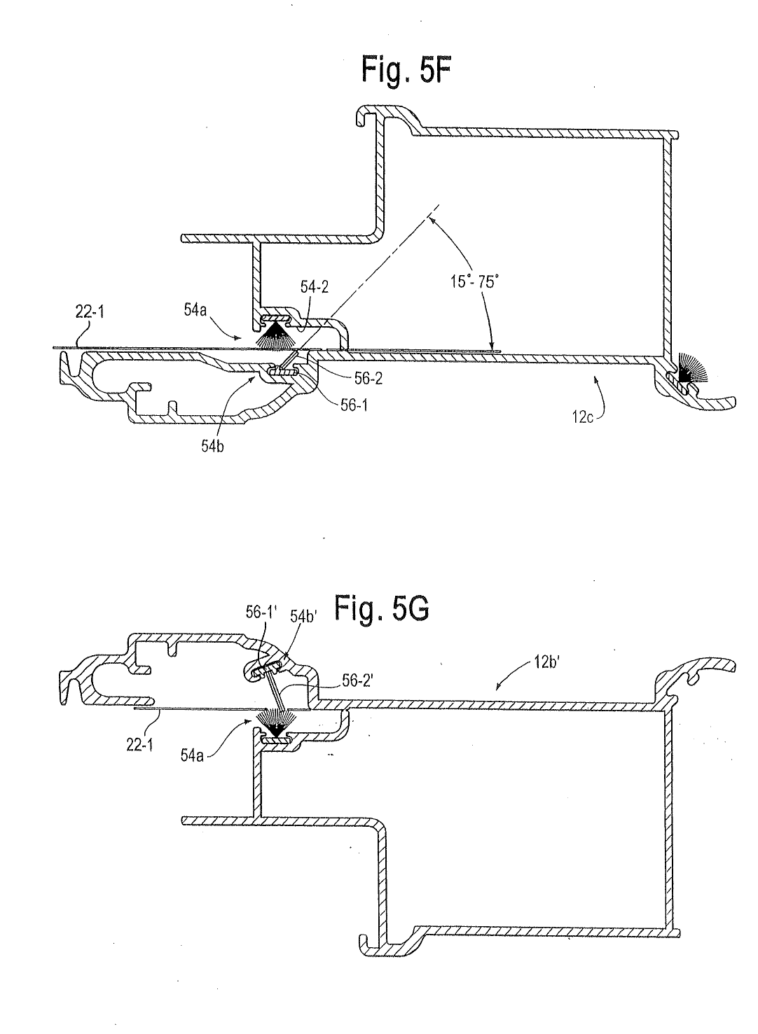

FIGS. 5A and 5B are sectional views taken along plane 5A-5A of FIG. 1A. The views of FIGS. 5A and 5B illustrate the relationship of various structural elements of the door 10 as the insert 14c moves from a fully closed position, FIG. 5A, to a partially open position, FIG. 5B. FIG. 5B illustrates the extended screen fabric 22-1.

As illustrated in the embodiment of FIG. 5C, a section taken along plane 5C-5C of FIG. 1A illustrates the insert tracks 52b and 52c which run axially along each of the jambs 12b and 12c. The insert 14c moves axially in and is retained within insert tracks 52b and 52c.

As illustrated in FIG. 5B, the insert 14c which is coupled to the screen material 22-1 moves axially in tracks 52b and 52c between insert 14b and mullion 18a. The screen end retaining member 22 may be slidahly received in or couplable to a rctaining feature 50 located at an upper end ol the insert 14c.

FIG. 5D illustrates the counterbalance mechanism 36a and 36b which is carried by the insert 14c. Hence, insert 14c can be located at any vertical position on its range of travel as defined by the tracks 52b, 52c along the jambs 12b,c. When so positioned, the screen material 22-1, will be extended from the screen module 20 to the retainer feature 50 to close the opening in the frame of the door 10 left by moving the insert 14c to a position closer to the kick plate 14a.

FIG. 5D also illustrates the screen material 22-1, illustrated in phantom, extended, as in FIG. 5B, extending between first and second weather stripping or sealing elements 54a and 54b. Weather stripping or sealing element 54a may extend axially along the respective jamb 12b and 12c on each side of the door 10. The weather stripping or sealing element 54a can be any form of weather stripping or other screen retention or insect barrier material/structure as would be known to those of skill in the art.

Weather stripping or sealing element 54b can be, different and unlike the weather stripping or sealing element 54a. The weather stripping or sealing element 54b can be positioned in an axially oriented slot that runs along the jambs 12b and 12c. Weather stripping or sealing element 54b may be commercially available from Reddiplex Group PLC, Worchestershire, England, under the trade name “MESHLOCK” and can be formed with a mounting section 56-1 which slidably engages the respective slot in the jamb 12b and 12c. The mounting section 56-1 carries a deflectable planar element 56-2 which extends from the mounting section 56-1 toward the weather stripping or sealing element 54a at a predetermined angle in a range of 15-75° relative to the plane of the screen. It will be understood that other commercially available forms of weather stripping or screen retention elements can be used instead of the MESHLOCK brand without departing from the spirit and scope of the invention.

The weather stripping or sealing element 54a can act to press the edge of the screen material 22-1 toward the weather stripping or sealing element 54b, as illustrated in FIG. 51F. This interaction provides a screen edge retention function and/or insect entry prevention barrier. MESHLOCK weather stripping 54b can resist screen material 22-1 from being pulled from between weather stripping 54a and 54b, and the tracks 54-1 and 54-2. This interaction also prevents insects from passing between the edge of the screen material 22-1 and the tracks 54-1 and 54-2.

It will be understood that while the MESHLOCK or other weather stripping 54b has been illustrated in FIGS. 5D and 5F as exhibiting an acute angle between the mounting section 56-1 and the screen retaining section 56-2, other variations of MESHLOCK or other weather stripping or sealing elements could be used. In one embodiment, as in FIG. 5C, the members 56-1′, -2′ could be oriented at 90° to one another. In this embodiment, the track in which the mounting section 56-1′ would be located would be oriented at an appropriate angle, best seen in FIG. 5G, relative to the respective jamb 12b and 12c to provide the desired interaction of pressing the screen material 22-1 between the weather stripping or sealing elements 54a, 54b′.

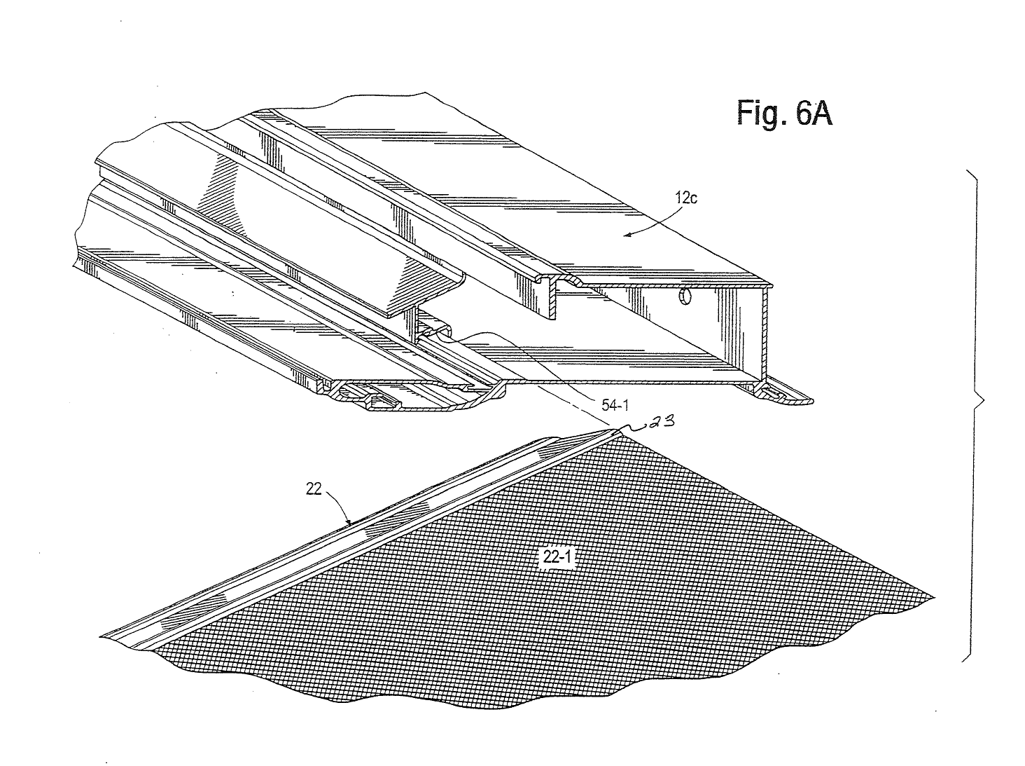

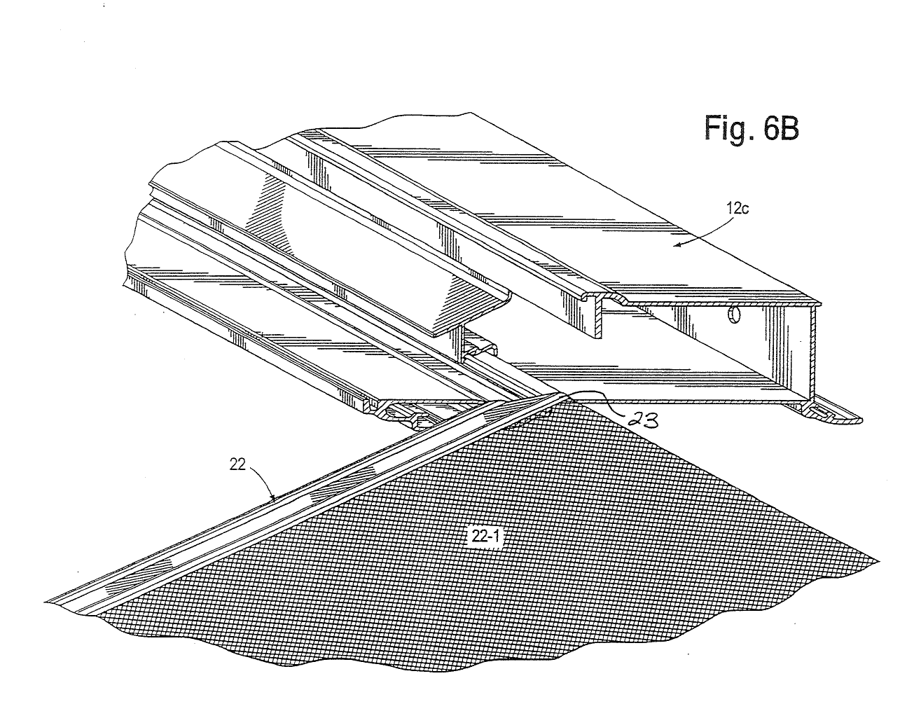

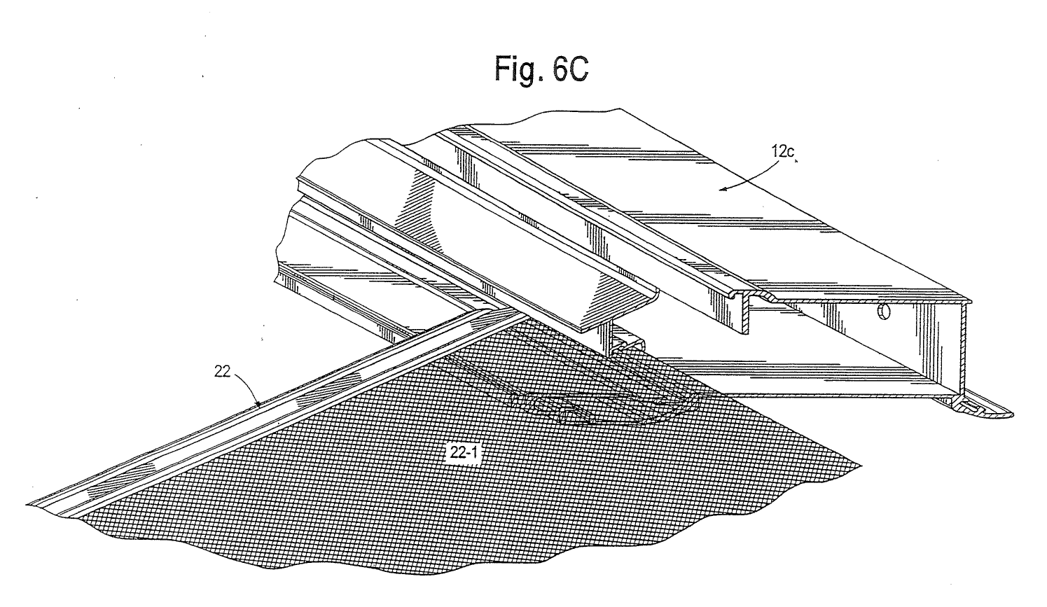

FIGS. 6A-6C taken together illustrate screen material or cloth 22-1 slidably engaging axial track 54-1, similarly 54-2. located in each of the jambs 12b and 12c and which extend axially along the jamb. The end attachment feature 22 also slidably engages the track or slot 54-1, -2 on each of the jambs 12b,c.

Though the screen cloth or material 22-1 may be forced out of the respective tracks 54-1, -2 in each of jambs 12b, c by a laterally directed force, the screen attachment member 22 will continue to remain in each of the tracks. This is facilitated by the shape and positioning of the screen attachment member 22 which includes an end region 23 which extends into the track and which may extend into the respective slot 54-1, -2.

In this instance, assuming that the screen cloth 22-1 has been forced from the respective track 54-1, the upper insert 14c can be moved to its fully closed position adjacent to header 12a to retract the screen onto the screen roll 28. In this circumstance, the attachment feature 22 is properly aligned to re-enter the tracks 54-1. As the insert 14c is moved away from the header 12a, it will pull the attachment member 22 with it. The ends 23 of the attachment member 22 will enter the respective slots 54-1 pulling the screen material 22-1 with them and retracking the screen. Alternately, the attachment member 22 can exhibit a retracted condition, adjacent to the screen module 20 while continuing to remain in the tracks 54-1.

Thus, as described above, if a force is exerted against the screen material 22-1 to pull it out of the side tracks 54-1 in each jamb, it is only necessary to reclose the insert 14c to rewind the screen material 22-1 into a proper configuration so that it will be immediately re-extendable into the slots or tracks 54-1.

FIGS. 7A, 7B and 7C illustrate additional details of the screen module 20. The module 20 is supported adjacent to the header 12a by brackets 30-1, -2. Screen module 20 can be removably attached to the header, the sill or the jambs. The module 20 is removable from the brackets 30-1, -2 for maintenance and/or replacement once the cover 24 has been removed from the respective door.

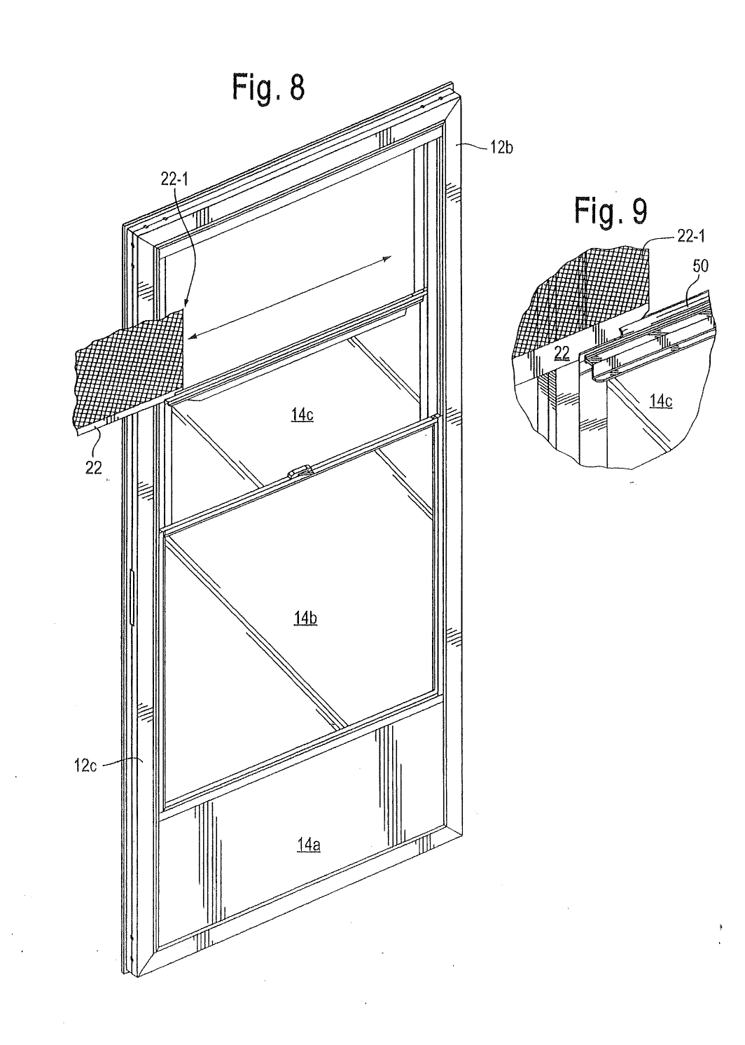

FIG. 8 illustrates additional details of removing and replacing the screen module 20. The connecting member 22 can be slid from the retaining feature 50 of the insert 14c as illustrated in FIGS. 8 and 9. When so-slid from the retaining feature 50, the entire module 20 can be replaced. Replacement involves attaching the connecting member 22 of the new module to the attachment feature 50 by reversing the process illustrated in FIGS. 8 and 9. The screen roll 28 and screen fabric 22-1 can then be reattached by brackets such as brackets 30-1, -2 in the header of the respective door. The cover 24 can be replaced. Moving the insert 14c vertically toward and away from the header will cause the screen fabric 22-1 of the replacement module to retract and extend as expected.

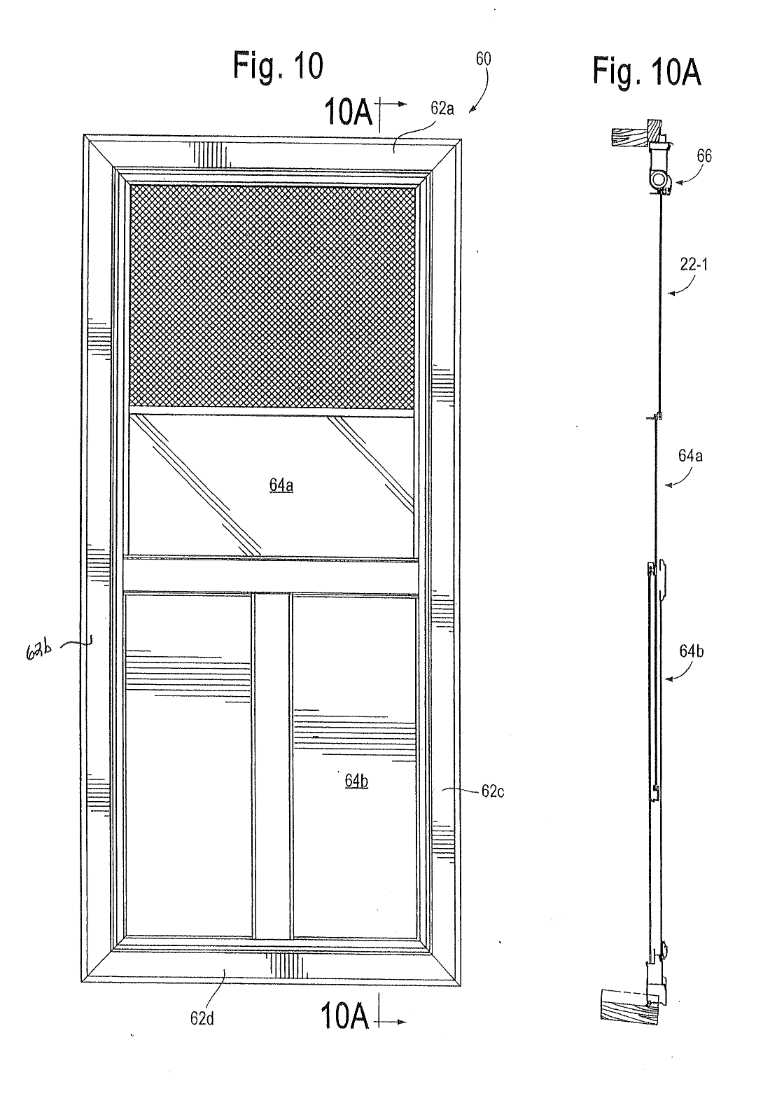

FIGS. 10 and 10A illustrate a door 60 which has a header 62a, jambs 62b,c and a sill 62d. The door 60 includes insert 64a which is movable vertically toward the header 62a and away therefrom toward the sill 62d. The insert 64a can be supported by counterbalances, latches or frictional forces as discussed above relative to the door 10.

The door 60 carries a screen module 66, best illustrated in FIG. 10A. A free end of the screen of the screen module 66 is coupled to an upper end of insert 64a as discussed above.

A lower panel 64b of the door 60 is hollow and contains a space into which the insert 64a can be stored as it is moved downwardly toward the sill 62d. In this configuration, where the insert 64a is partly open, a portion of the screen 66a extends from the screen module 66 and fills the open space between jambs 62b,c and header 62a. The remainder of the space between the jambs 62b,c is filled by a portion of the insert 64a and the panel 64b. Thus, the door 60 provides convenient out of sight storage for the insert 64a.

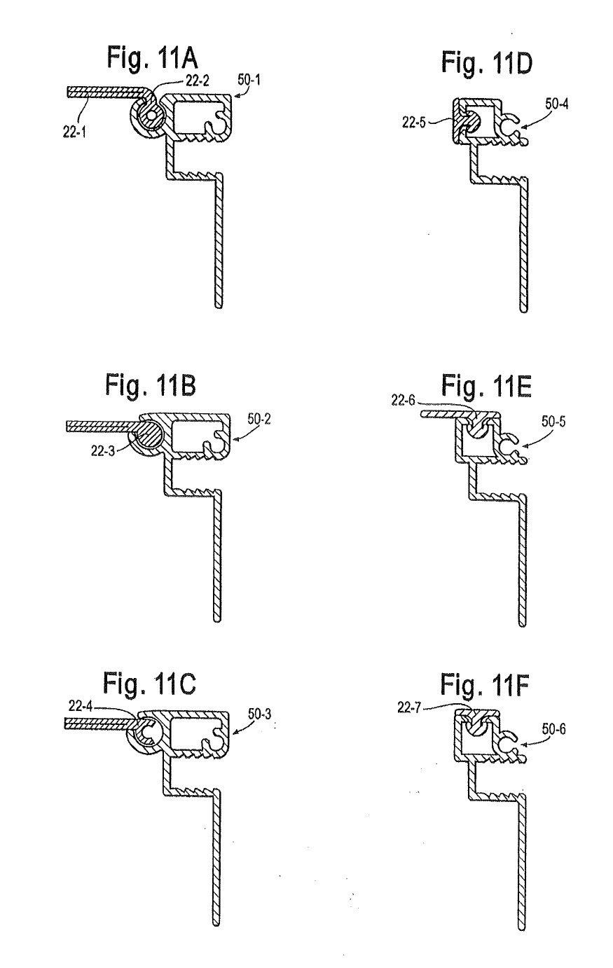

FIG. 11 illustrates a plurality of alternate coupling members 50-1 . . . 50-6 that could be carried on the movable insert or pane, such as the insert 14c, and couplable to a free end of the screen fabric 22-1. As illustrated in FIG. 11, in each instance, the free end of the screen 22-1 would include a coupling element, such as 22-2 . . . 22-7 which would slidably engage or couple the respective coupling member 50-1 . . . 50-6.

It will be understood that other arrangements can be used to attach a free end of the screen member 22-1 to a moving insert or pane. Alternates may include a spline which would trap the free end of the screen fabric 22-1 in contact with the movable inserts such as 14c, hooks, rails, clamps, adhesives etc. Other connectivity options and structures come within the spirit and scope of the invention.

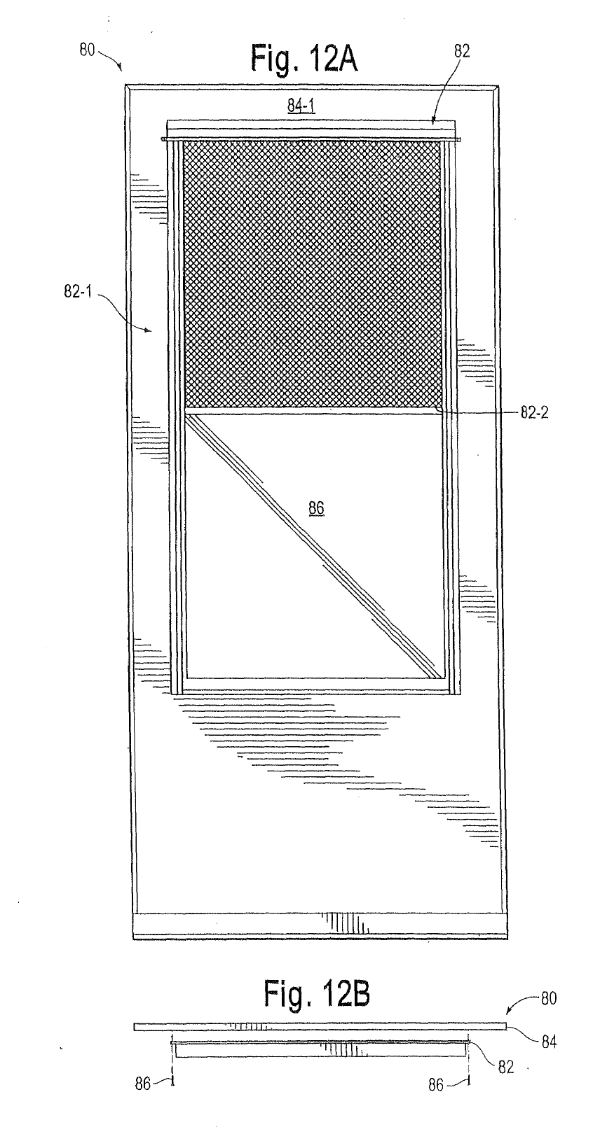

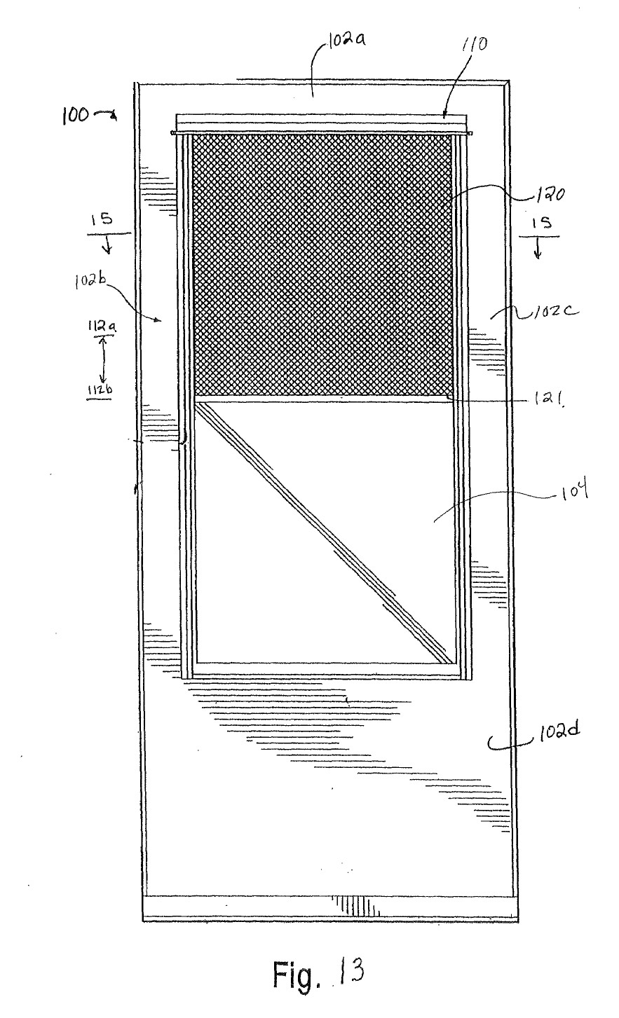

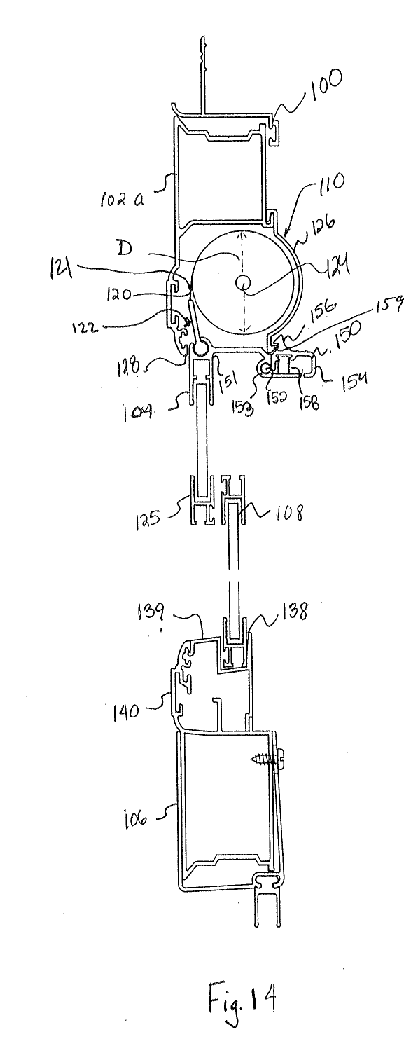

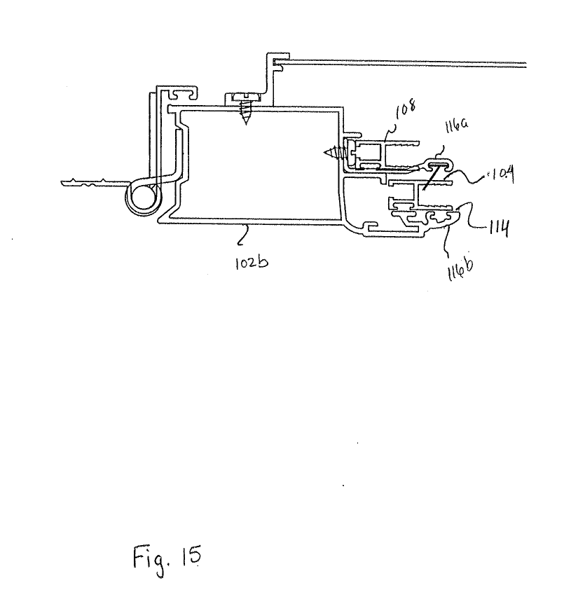

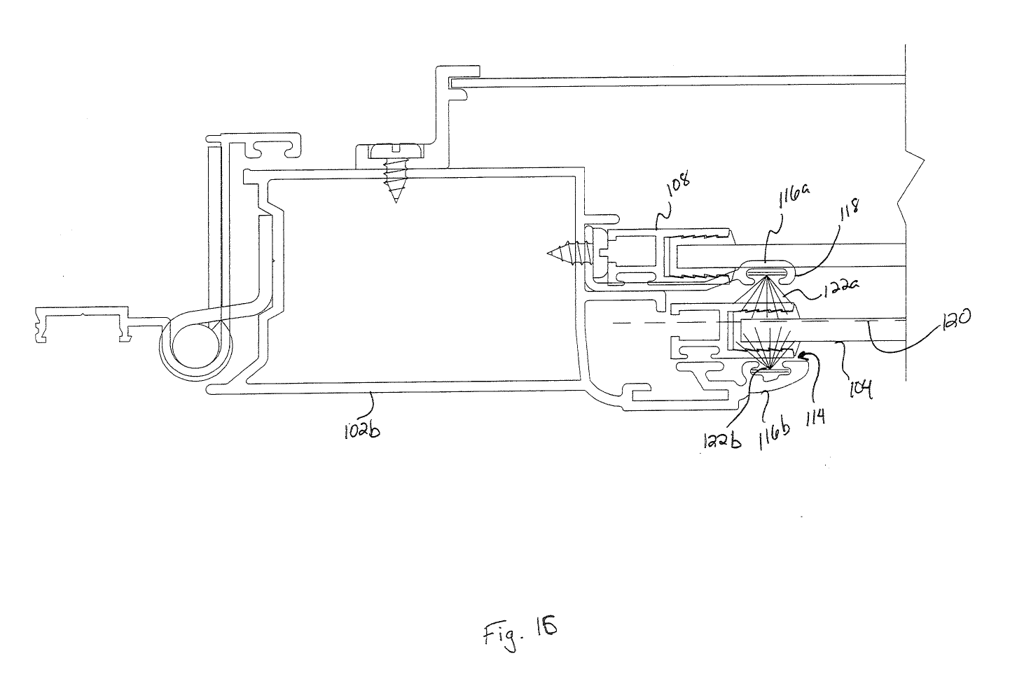

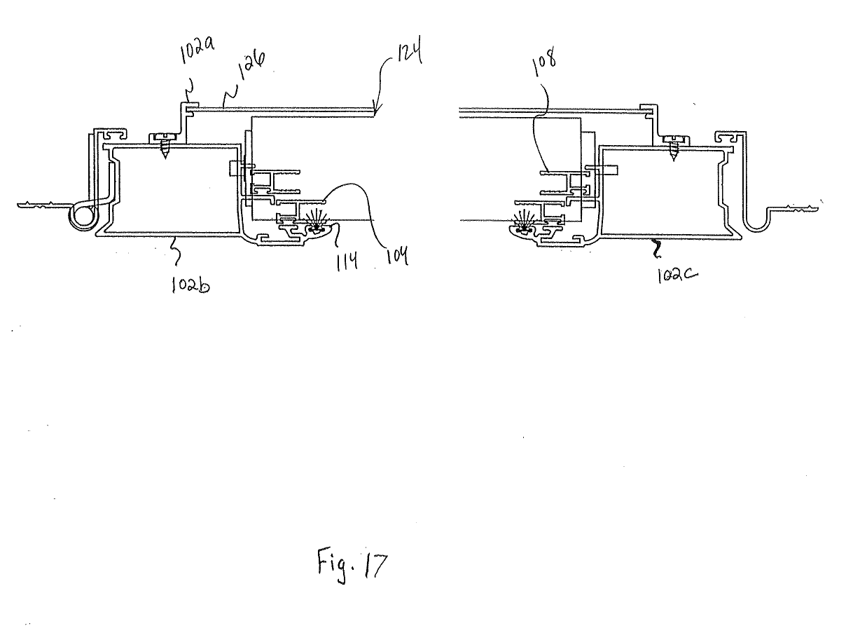

FIG. 12 illustrates a door 80 which incorporates a screen module 82, of the type discussed previously, which can be attached to door 84 as an after the fact accessory or add-on. The module screen 82 can be attached to the door 84 by fasteners 86 in the vicinitv of the header 84-1 of the door.

The screen fabric 82-1 can be pulled from the module 82 to close an opening in the door created by moving insert 86 downwardly away from the module 82. A free end 82-2 of the screen material 82-1 is attached to the sash or insert 86. Attachment can be effected by any of the previously discussed methods including using a spline, adhesive, or providing attachment clips or rails which slidably engage or couple to a portion of the insert 86. A myriad of other attachment vehicles can be used to connect the free end 82-2 to an upper end of the insert or sash 86 without departing from the spirit and scope of the present invention.

As the sash or insert 86 is moved toward the screen module 82, the fabric 82-1 rollably retracts into the module 82 as a result of the internal spring mechanism, discussed above, in connection with door 10. The screen material 82-1, also as discussed above, is under a constant pulling force due to the spring biasing mechanism of the module 82 which continually attempts to retract the fabric 82-1 into the module 82. Thus, as the sash or insert 86 moves toward the module 82, the screen material 82-1 is immediately rolled into the module 82 for out of the way storage.

It will also be understood that a resin or plastic sheet could be used as an alternate to screen fabric 82-1 without departing from the spirit and scope of the present invention. Thus, the screen module 82 provides a mechanism for adding to any existing door, after installation, a retractable screen feature such that existing screen panels or inserts in the door can be removed. This improves convenience and visibility in that with the sash or insert 86 closed, the screen fabric 82-1 is completely retracted and an individual looking at the door looks directly through the glass inserts or sashes without having to look through a screen.

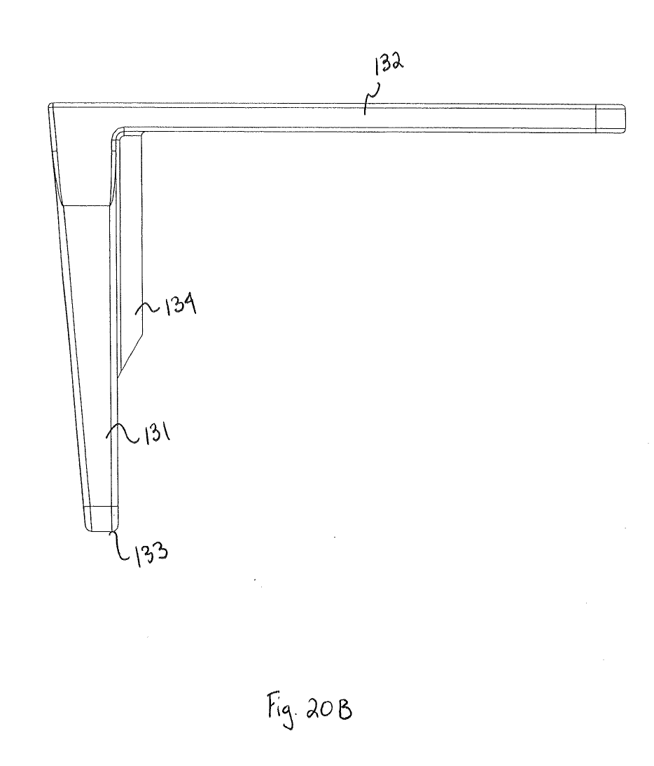

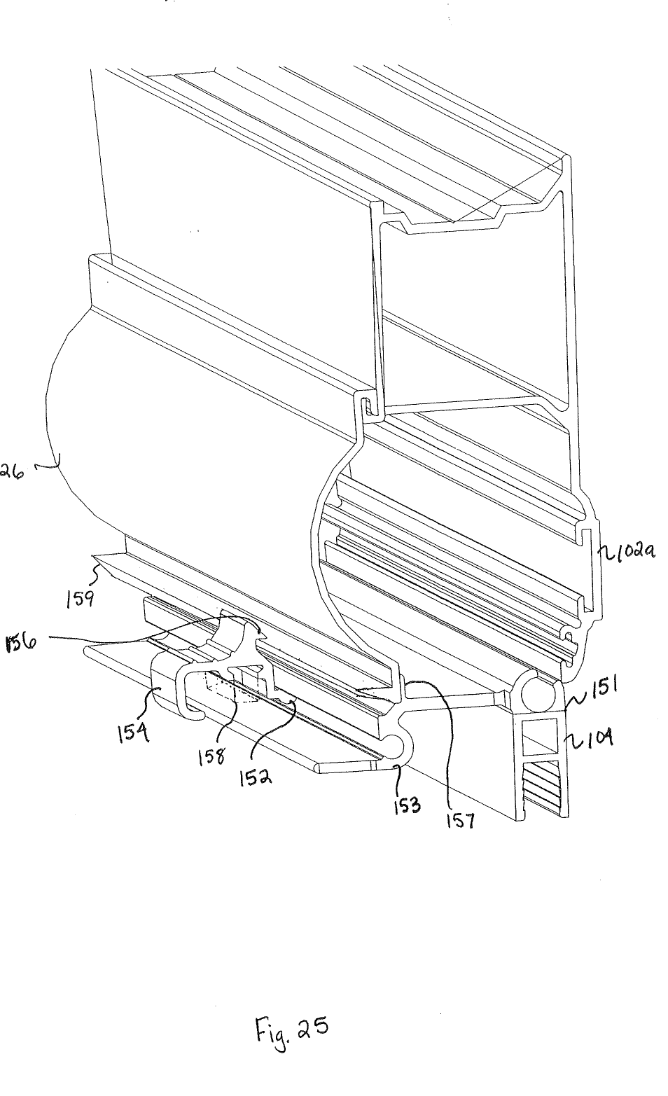

In another embodiment, as illustrated in FIGS. 13-25, a door 100 is provided that includes a header 102a, two door jambs 102b, 102c and a sill 102d, or kick plate, that define the doorframe. A replaceable screen module 110 is disposed in or on the door 100. The replaceable screen module includes a spring biased roll 124 that has a retractable screen 120 attached thereto. The retractable screen 120 includes an end that is couplable to a movable glass insert or window insert 104 in the door 100. As the window sash or insert 104 is moved away from the screen module 110, the screen 120 is withdrawn from its retracted position and extends along a frame of the door 100, screening the otherwise open region from which the window sash 104 has moved. As the window sash or insert 104 moves toward the screen module 110, the screen 120 is retracted into the screen module 110 reducing the ventilation region available in the door 100.

The door 100 may also include a kick plate 106 and a fixed lower pane or glass insert 108. In the door 100, the pane or insert 108 is fixedly mountable between the jambs 102b,c and above the kick plate 106.

In this embodiment, the pane or insert 104 and screen 120 are mounted in at least one track, discussed in more detail subsequently, for vertical motion generally in directions 112a and 112b relative to insert 108. When the insert 104 is positioned at its uppermost location generally adjacent to the header 102a, the door 100 is fully closed with two glass panes as one would use in cool or wet weather. The pane or insert 104 can be moved. vertically, in direction 112b, away from the header 102a thereby opening the upper portion of door 100 for ventilation,

Referring to FIGS. 13 and 14, screen module 110, can be coupled to the jambs 102b, 102c, header 102a or sill 102d. Screen module 110 carries a retracted screen 120 which has a free end 121 that carries an attachment member 122 that is coupled to an upper end of insert 104. As the insert 104 is moved in the direction of 112b, screen fabric or material 120 from the screen module 110 is extracted therefrom filling any gap or space between an upper end Of the insert 104 and the header 102a. As the insert 104 is moved in the direction of 112b, the screen material 120 is kept generally taut within the at least one track.

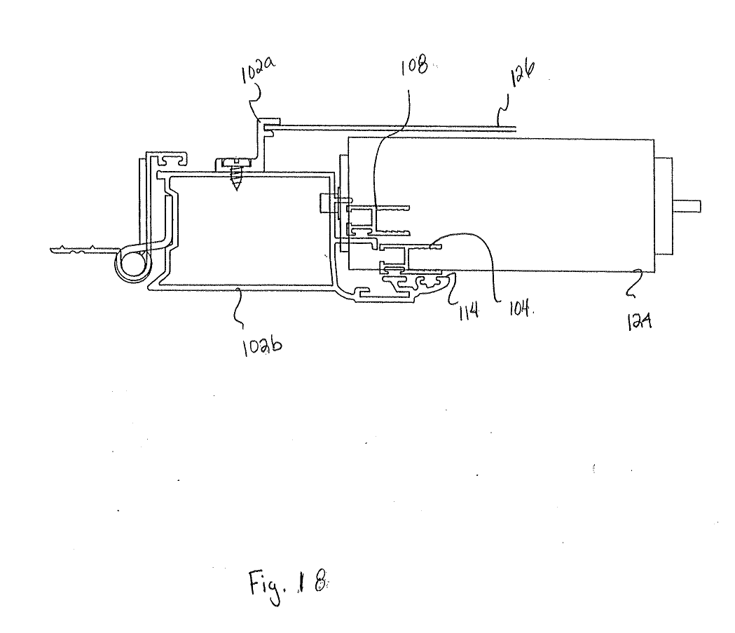

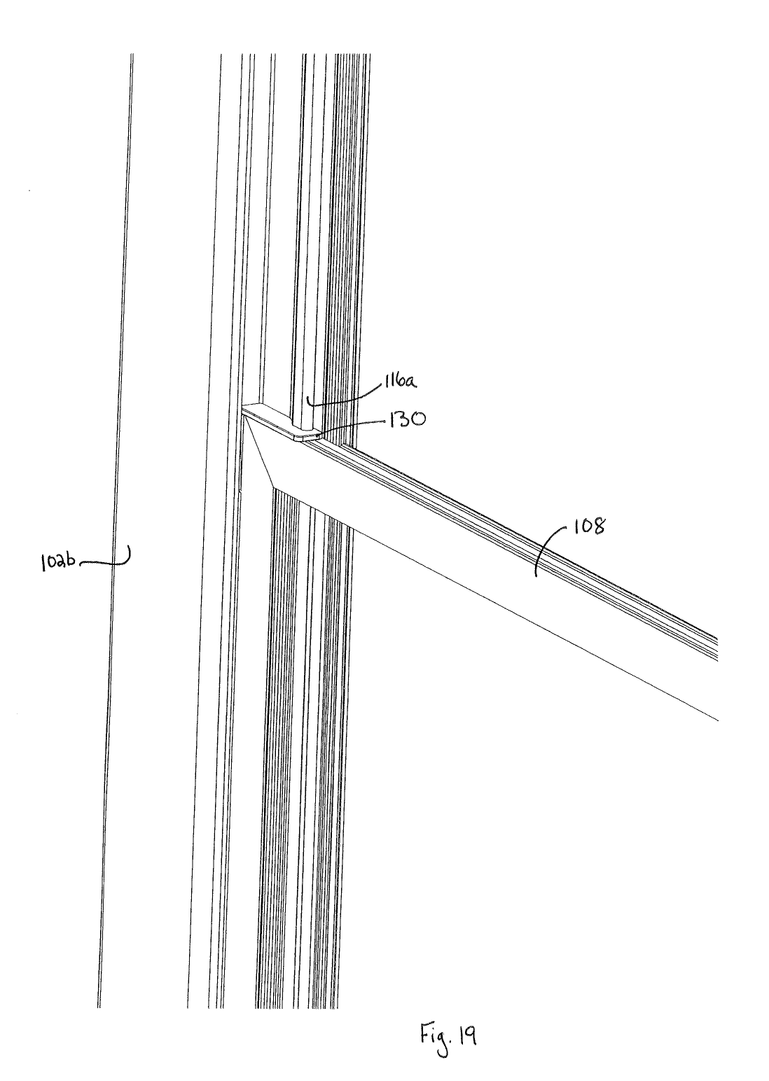

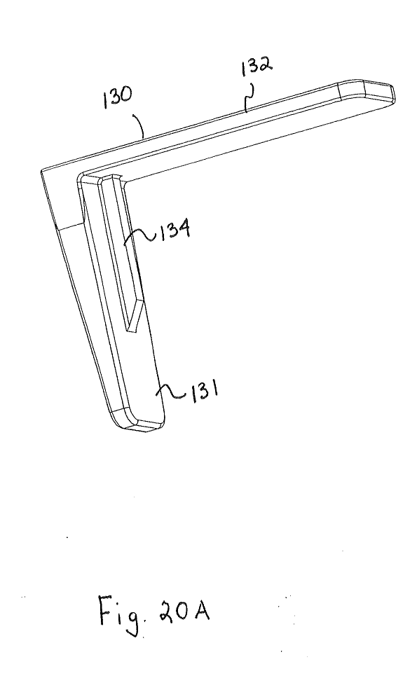

As illustrated in FIG. 15, the insert 104 may be disposed in at least one track 114 that extends axially along jambs 102b and 102c. As particularly illustrated in FIG. 16, the screen material 120, illustrated in phantom lines, may extend into and may travel along the at least one track 114 as the insert 104 moves between the 112a and 112b positions of FIG. 13.

In one embodiment, as illustrated in FIG. 16, the at least one track 114 may be defined by a pair of spaced apart side walls 116a and 116b with at least one of the spaced apart side walls 116a or 116b being removably couplable to a respective spaced apart jamb 102b or 102c. At least one of the spaced apart side walls 116a and 116b can be generally angled toward the other spaced apart side wall such that a width of a space between the spaced apart side walls narrows from an edge 118 of the spaced apart side walls 116a or 116b toward the jambs 102b or 102c. The narrowing width of the at least onc track 114 aids in retaining the screen material 120 in the at least one track 114.

The screen material 120 may be disposed between or sandwiched between weather stripping or sealing elements 122a and 122b formed on, integrated with or coupled to the spaced apart side walls 116a and 116b. The sealing elements 122a and 122b act to retain the screen material 120 in the at least one track 114 and to prevents insects from passing between edges of the screen material 120 and the at least one track 114. Weather stripping or sealing element 122a and 122b may extend axially along the respective jamb 102b and 102c on each side of the door 100. The weather stripping or sealing element 122a and 122b can be any form of weather stripping or sealing/barrier structure as would be known to those of skill in the art.

Referring back to FIG. 14, when substantially all of the screen material 120 is wrapped around the spring biased roll 124, it defines a wrapped diameter, indicated bv the letter D, for the spring biased roll 124. The wrapped diameter D, in one embodiment, can be at least as large as the thickness of the header 102a. The wrapped diameter D for the spring biased roll 124 may be offset longitudinally from the header 102a such that a portion of the wrapped diameter D extends out from the header 102a. The header 102a may include a detachable cover 126 to cover the spring biased roll 124 that extends out from the header 102a. The cover 126 may have a generally arcuate shape, however, other shapes may also be used.

As the insert 104 is drawn away from the header 102a. the screen material 120 is deployed from the offset spring biased roll 124 proximate a door frame first surface 125. The edges of the screen material 120 are forced into abutment against the at least one track 114 and/or the sealing element 122a or 122b. The screen material 120 is urged along the at least one track 114 which is oriented generally parallel to and within the door width generally inward from an outer surface of the doorframe or jamb. This abuttably realigns side portions of the screen material 120 tautly against the at least one face surface of the at least one track 114.

In another embodiment, the screen material 120 may be kept taut by a longitudinal edge portion 128 that extends along the header 102a (as illustrated in FIG. 14) or from the offset track or tracks (not shown). The screen material 120 is kept taut by the longitudinal edge portion 128 of the header 102a or the offset track by extending toward and generally displacing the screen material 120 from a path of travel off the spring biased roll 124 or within the at least one track 114. A tension member or mechanism (not shown) may be couplable to the longitudinal edge portion 128 of the header 102a and may extend longitudinally along at least a portion thereof for further confronting and displacing the screen material 120. The tension member may be weather stripping, sealing element or any other material that extends generally transversely away from the longitudinal edge portion 128.

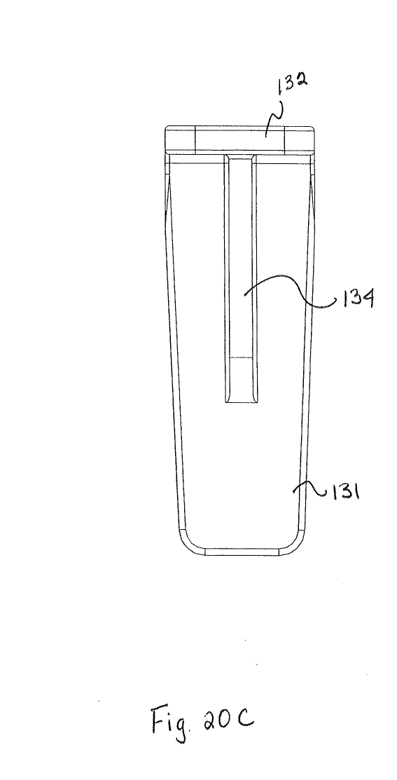

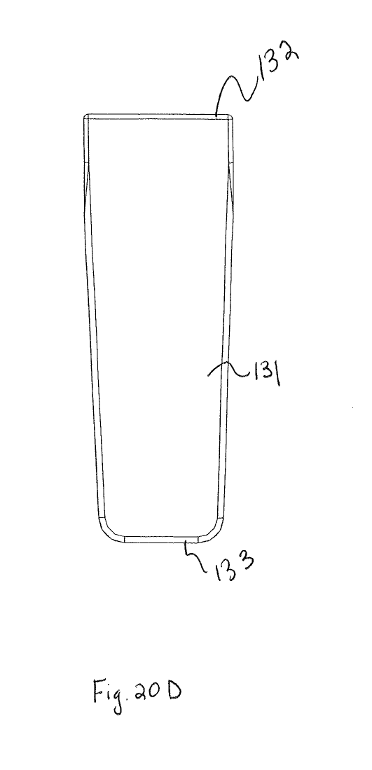

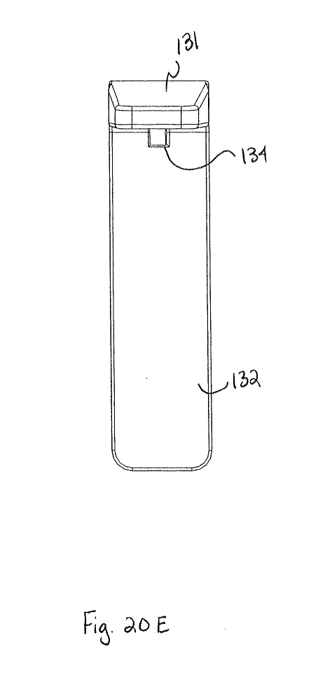

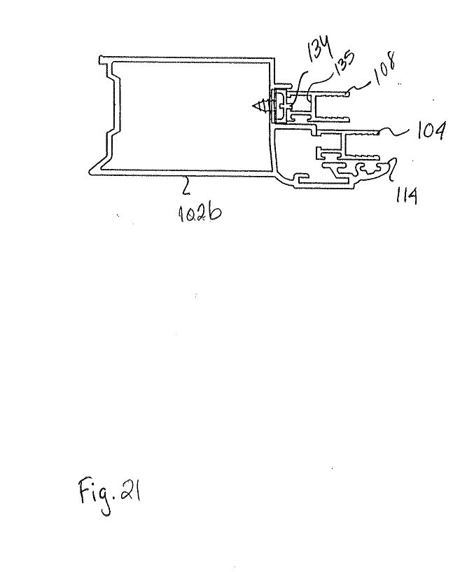

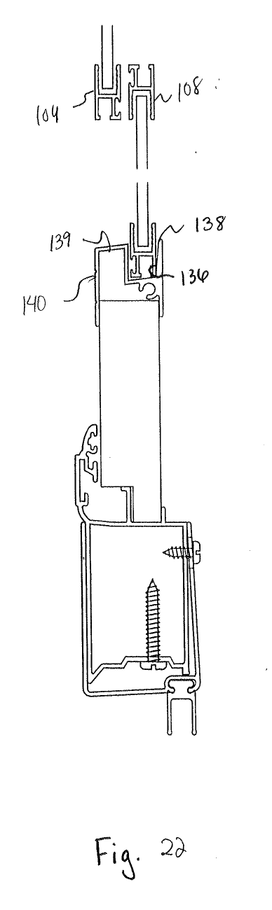

Referring to FIGS. 19-20E, an upper end of the insert 108 may be fixedly mounted between the jambs 102b and 1 02c by at least one stop 130. The stop 130 may be disposed in the at least one track 114 and disposed between insert 108 and respective jambs 102b and 102c. In one embodiment, as illustrated in FIG. 20A, the stop 130 may include a wedge portion 131 for inserting between the insert 108 and respective jambs 102b or 102c. A rest portion 132 is disposed at one end of the wedge portion 131 for resting upon the insert 108 and stopping movement of the wedge portion 131 between the insert 108 and respective jambs 102b or 102c.

As particularly illustrated in FIG. 20B, the wedge portion 131 can have a thickness that tapers from the rest portion 132 toward a free end 133 of the wedge portion 131 in order to restrict movement of the insert 108 in the at least one track 114. As illustrated in FIG. 20D, the wedge portion 131 may also have a width that tapers from the rest portion 132 toward the free end 133 of the wedge portion 131. A rib 134 may extend generally transversely away from the wedge portion 131 and may extend generally from the rest portion 132 toward the free end 133 of the wedge portion 131. Referring to FIG. 21, the rib 134 can be nestably disposed in a corresponding groove 135 that extends into the insert 108. If a force is exerted on the insert 108, the insert 108 engages the rib 134 which transfers the force to the wedge portion 131, which engages the at least one track 114 and prevents lateral movement of the insert 108 out of the door 100.

In another embodiment of the invention, the rest portion 132 of the stop 130 may be disposed in a corresponding channel (not shown) extending into the insert 108 such that the stop 130 is generally invisible to a user. The stop 130 may comprise any material such as rubber, metal, wood, plastic or the like. Other materials are also envisioned to be within the scope and spirit of the invention.

As illustrated in FIG. 19, one of the spaced apart side walls 116a or 116b, is disposed proximate or against the rest portion 132 of the stop 130. The spaced apart side wall 116a or 116b further restricts movement of the stop 130 away from the insert 108. In an embodiment without a stop 130, the spaced apart side wall 116a or 116b may restrict movement of the insert 108 along the path 112a and 112b.

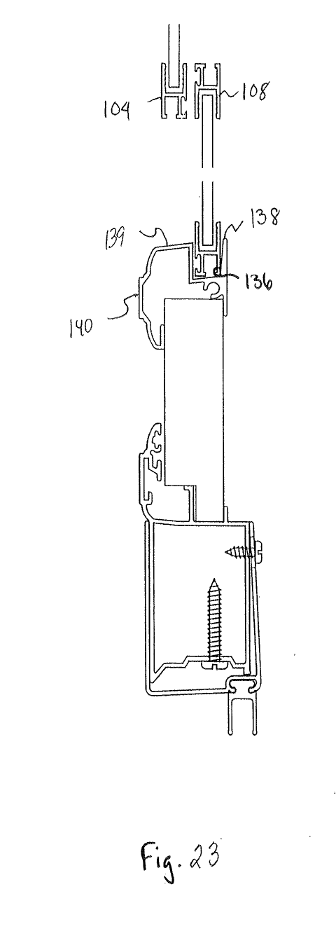

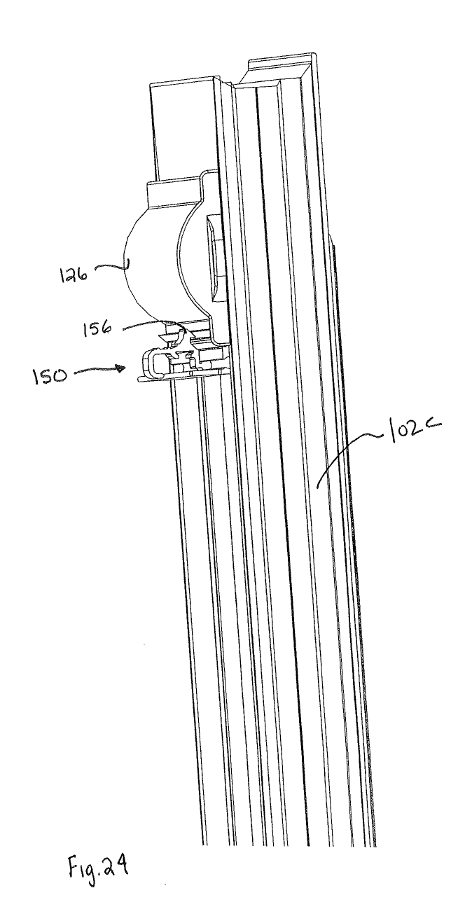

Referring to FIGS. 22 and 23, a lower end 136 of the insert 108 may be removably disposed in a channel 138 formed in an upper surface 139 of a mullion 140 extending between the jambs 102b and 102c. Having the insert 108 nested in the channel 138 restricts lateral movement of the insert 108 away from the door 100. In this embodiment, the channel 138 can extend the length of the mullion 140. In an embodiment of the invention having stops 130, the insert 108 may be removed from the door by removing the stops 130 and lifting the insert 108 out of the channel 136.

Referring back to FIG. 14 and FIGS. 24-25, the moveable insert 104 may include a latch or catch mechanism 150 that is pivotally coupled to an upper end 151 of the insert 104 to prevent movement of the insert 104 in the direction of 112b of FIG. 13. The catch mechanism 150 is releasably couplable to a receiving portion of the door 100. In one embodiment, the catch mechanism 150 is releasably couplable to the header 102a when the insert 104 is positioned at its uppermost position proximate the header 102a. In another embodiment, the catch mechanism 150 can be releasably couplable to other portions of the door 100, such as, for example, the sill 102d or the spaced apart jambs 102b and/or 102c.

The catch mechanism 150 may include a boss portion 152 pivotally disposed in a seat 153 provided with the adjustable insert 104 and an arcuate handle portion 154 extending away from the boss portion 152 for grasping by a hand of a user. The catch mechanism 150 may further include a hook portion 156 for engaging the header 102a, a portion of the screen module 110, or if a cover 126 is used, the cover 126 of the door 100. In this embodiment, the header 102a or cover 126 may be disposed over the screen module 110 and may include a lip or other receiving mechanism/portion 159 for receiving the hook portion 156. In another embodiment of the invention, as particularly illustrated in the cross-sectional view of FIG. 25, the seat portion 153 may include a generally elongate element 157 that extends transversely away therefrom for creating a seal between the cover 126 and the insert 104. In this particular embodiment, the elongate element 157 is disposed generally behind the cover 126 and may be abuttable against the cover 126.

In one embodiment, a biasing member 158 may be disposed between the handle portion 154 and the insert 104 for biasing the handle portion 154 away from (i.e., upward from) the insert 104 and toward the cover 126 to ensure coupling of the catch mechanism 150 to the receiving portion 159. The biasing member 158 may be a leaf spring. However, other types of biasing members may also be used. To detach or uncouple the catch mechanism 150 from the header 102a or cover 126, a user depresses or actuates the handle portion 154 toward the insert 104 until the hook portion 156 disengages the receiving portion 159. After disengagement the biasing member 158 biases the handle portion 154 back toward the header 102a or receiving portion 159.

In another embodiment, the handle portion 154 may be resiliently flexible with respect to the boss portion 152 such that depression of the handle portion 154 toward the insert 104 generally draws the hook portion 156 away from its resting state and away from the receiving portion 159 which can be the lip 159 of the cover 126. In this particular embodiment, after being moved from its resting state, for disengagement of the insert 104 from the receiving portion 159, the handle portion 154 will resiliently return to its resting state for engagement to the receiving portion 159 of the header 102a or cover 126. Other embodiments and configurations for the catch mechanism 150 are envisioned to be within the spirit and scope of the invention.

From the foregoing, it will be observed that numerous variations and modifications may be effected without departing from the spirit and scope of the invention. It is to be understood that no limitation with respect to the specific apparatus illustrated herein is intended or should be inferred. It is of course, intended to cover by the appended claims all such modifications as fall within the scope of the claims.

What is claimed is:

1. A catch mechanism for securing a selectively shiftable element received in a storm door, the catch mechanism comprising:
a handle body presenting a first end with a projecting boss portion and a lip structure, the lip structure spaced apart from and extending generally parallel with the boss portion, the boss portion receivable in a seat defined in the shiftable element such that the handle body is selectively pivotable relative to the shiftable element between a first position in which the lip is engagable with a corresponding receiving structure on the storm door to inhibit movement of the shiftable element, and a second position in which the lip is clear of the receiving structure of the storm door to enable movement of the shiftable element; and
a spring engagable with a portion of the shiftable element to bias the handle body toward the first position.
